(19) United States
(12) Patent Application Publication
(10) Pub. No.: US 2019/0352785 A1
(43) Pub. Date: Nov. 21, 2019

(54) ELECTROCHEMICAL DEPROTECTION FOR SITE-SELECTIVE IMMOBILIZATION AND LOCAL ASSEMBLY OF MOLECULES BY CLICK-CHEMISTRY

(71) Applicants: International Business Machines Corporation, Armonk, NY (US); Universität Basel, Basel (CH)

(72) Inventors: Manuel Hellstern, Basel (CH); Markus Gantenbein, Zurich (CH); Gabriel F. Puebla Hellmann, Zurich (CH); Marcel Mayor, Basel (CH); Emanuel M. Lörtscher, Bonstetten (CH)

(21) Appl. No.: 15/981,690

(22) Filed: May 16, 2018

(51) Int. Cl. C25B 3/04; C07B 31/00; C25B 9/00

(52) U.S. Cl. CPC C25B 3/04; C25B 9/00; C07B 31/00

(57) ABSTRACT

A method and devices for deprotecting anchored molecular compounds is provided which relies on an electrically addressable surface S with multiple compounds C thereon. Each compound C comprises three distinct moieties, including: a first moiety A, anchored to the surface S; a second moiety, which comprises an acetylene unit U, that is a molecular backbone bonded to the first moiety; and a third moiety P, which is a protection moiety for acetylene. The protection moiety P is bonded to the acetylene unit U of the second moiety via an electrochemically breakable bond. The surface S is submerged in an electrolyte, so that the compounds C are immersed in the electrolyte. The protection moiety P of at least a subset of the compounds C can be electrochemically cleaved by applying an electric potential between the surface S and the electrolyte, so as to obtain cleaved compounds C′ with free acetylene terminals.

### BACKGROUND

This invention relates generally to methods for deprotecting anchored molecular compounds, and more particularly is directed to methods and systems for electrochemically cleaving protection moieties P of such molecular compounds C, so as to release acetylene terminals T, which can subsequently be used for local and site-selective assembly of molecules, e.g., by click chemistry.

Molecules can be regarded as the smallest nature- and man-made building blocks used in a variety of tasks in chemistry, biology, medicine, and physics. Intra- and intermolecular functionalities are used in biological processes (metabolism, homeostasis, immunology, reproduction, photosynthesis, etc.), optical processes (absorption, emission, etc.), sensing (molecular recognition, analyte binding etc.) or electronics (resistance switching elements, charge storage elements, etc.).

In order to exploit the microscopic properties of molecular compounds in device-like, man-made structures and take advantage of such compounds (e.g., as ensembles, monolayers or single-compound entities, be they made by nature and/or synthetically), these compounds need to be immobilized at specific sites in the device. This, however, is a major challenge due to their small size and sensitivity towards traditional fabrication processes. Hence, there is a general need across various disciplines for localized immobilization and assemblies of different molecular species at specific sites (referred to as “site-selective” immobilization and local assembly).

Local drop casting is a technique that can be employed from millimeter down to micrometer size scales. Spatial constraints and surface chemistry are required to achieve local deposition (e.g., control of the wetting properties by hydrophobic-hydrophilic interactions). The process is fundamentally limited by diffusion and furthermore very labor-intensive if not massively parallelized. Drop-casting requires direct physical access to the deposition site, which prevents application to closed volume-devices.

A widely-used concept to immobilize compounds on surfaces is based on anchor groups. Using chemisorption rather than physisorption provides an improved selectivity. The specific chemical bond to be established depends on the surface (composition and termination), to which molecules should adhere to. The chemical bond determines the properties of the adhesion to the specific surface. A variety of bonds is available, which range from weak (dipole-dipole interactions, hydrogen bonding, etc.) to strong (ionic, covalent/metallic) bonding. Covalent bonding realized, e.g., by thiols, nitriles, isocyanides, amines, and pyridines linkers, provides a sufficiently strong immobilization for use in most tasks, including exposure to liquid flow at high flow rates and, on a variety of surface materials, including noble metals such as Au, Pt, Pd, etc.

Yet, anchor groups are a viable way to immobilize molecules as long as only one type of molecule has to be assembled. Using anchor groups and corresponding metal surfaces, densely packed and oriented monolayers of molecules can self-assemble on the surface. In this case, a sufficient material contrast prevents molecules from binding at other sites and therefore provides the required site selectivity.

For more complex devices, however, assembling one type of molecular compounds is not sufficient and multiple compounds must be assembled either in one step or sequentially, at defined sites and sometimes in very close proximity, which prevents the use of macroscopic deposition techniques such as drop-casting. For sensing, one may want to use multiple species, which offer a larger range for detection, while components with different functionalities are required for fabricating, e.g., molecular electronic circuits, bio-sensors or catalyst networks, amongst other examples. Local assembly can in principle be achieved on micrometer scales, provided suitable material contrast and material-specific anchor groups are relied on. Such an approach, however, is limited by the availability of selective anchor groups and surface materials, which can make the fabrication and assembly processes very demanding. Given the limited selectivity and the range of possible anchor-group-material combinations, this approach is not scalable to more than 10 specific entities, whereas applications as currently envisioned would require hundreds to thousands of different molecules to be assembled site-selectively.

More importantly, repeatedly exposing new areas and volumes for the assembly of additional species is often not practical, if at all feasible, as the intermediate patterning and assembly processes require heat and harsh cleaning, which potentially results in removing already deposited species.

Molecular imprint techniques (MIP) are known, which rely on an artificial, tiny lock for a specific molecule to bind to the template that serves as miniature key for local binding. Here, a polymer is processed, yielding cavities in the matrix with high chemical affinity to a chosen “template” molecule. The chemical cavity is created inversely, which means that the chemical analyte must be immobilized first to create the template in the imprint process. This labor-intensive process may work well for certain molecules as long as molecular recognition and self-assembly can be employed. However, for more general purposes (in particular in conjunction with highly constrained micro- and nanometer-sized volumes such as compartments or channels), this concept cannot be employed.

Since many applications require some type of electrodes (metallic, semiconducting materials etc.) for later operation and the fact that molecules are most often deposited from solution (rather than being deposited by evaporation), electro-chemical methods become attractive for site-selective immobilization as they offer an additional handle to control the immobilization mechanism. There are mainly two strategies applicable:
1) Electro-reduction is used to activate the anchoring group of certain target compounds near the electrode under an electrical bias (with respect to the solution/electrolyte). However, this method can have substantial cross-talk in close-proximity, and is limited by: (i) the electric-field distribution of the electrodes, and (ii) the high electro-chemical potential required to cause the activation reaction, which may also damage the functional part of the compounds to be assembled.
2) Assembly of a functional “immobilization moiety” consisting of a group anchoring to a metal surface and an initially protected “binding moiety” able to subsequently bind the target molecules. The protection group can be locally removed by applying an electro-chemical potential, enabling a flexible, tunable and site-specific binding of target molecules.

Electro-chemical deprotection schemes have been described in literature, most often for assembly of biomolecules. The upper binding moieties mostly offer derivatives of carboxylic acids after release of the deprotection group. Examples include monocarboxylic ester of hydroquinone providing transacylation to various functional groups including various acids, alcohols, and amines, proteins (see Kim K, Yang H, Kim E, Han Y B, Kim Y T, Kang S H, Kwak J. Langmuir. 2002; 18(5):1460-1462). Activated esters are ideal to bind amines-containing biomolecules such as peptides via amide formation. In addition, larger architectures of amino-acids like proteins and enzymes expose amines, making them suitable for coupling chemistry.

However, and as it may be realized, such binding moieties are limited in their usage, in particular if mild conditions are required for subsequent binding of another compound. An easier accessible binding moiety for synthetic chemistry would be more favorable and generic, e.g., to enable “click chemistry”, and, this, in order to assemble other artificial moieties with larger degrees of freedom in their molecular design and breadth of functionalities.

### SUMMARY

According to a first aspect, the present invention is embodied as a method for deprotecting anchored molecular compounds. The method relies on an electrically addressable surface S with a plurality of compounds C thereon. Each compound C comprises three distinct chemical moieties, including: a first moiety A, anchored to the surface S so as to immobilize the compound C thereon; a second moiety B that is a molecular backbone B bonded to the first moiety A; and a third moiety P. The second moiety B comprises an acetylene (ethyne) unit U. The third moiety P is a protection moiety for acetylene, i.e., it can be regarded as protecting the acetylene unit U from spontaneous binding. The protection moiety P is bonded to the acetylene unit U of the second moiety via an electrochemically breakable bond b. Next, the surface S is submerged in an electrolyte, so as for the plurality of compounds C to be immersed in the electrolyte. Finally, the protection moiety P of at least a subset of the compounds C is electrochemically cleaved, via a respective one of the breakable bonds b, by applying an electric potential between the electrically addressable surface S and the electrolyte. This way, cleaved compounds C′ are obtained, which comprise a free acetylene (ethyne) terminal. I.e., a compounds C′ is cleaved at the level of the second moiety of the initial compound C and, after cleaving, each cleaved compound C′ comprises a free acetylene terminal T. E.g., a cleaved compound may for example be terminated by an acetylene terminal Tat its free end or the acetylene terminal T may hang free on a side of the cleaved compound.

As the protected acetylene unit U is immobilized on the surface (via the first moiety A and the second moiety B), the above deprotection mechanism leads to an acetylene functionalized, locally addressable surface. As such, it provides a chemically flexible attachment, which makes it possible to subsequently bind a large variety of functional compounds M to the cleaved compounds. The attached functional compounds can be natural and/or artificial molecular compounds. Remarkably, the functional compounds can be attached using simple chemical reactions, e.g., click chemistry techniques, and this, even under mild and ambient conditions, thanks to the released acetylene terminals T.

Preferably, the protection moiety P is chosen such that the above-mentioned deprotection mechanism can be based on an electrochemical reduction of the protection moiety P. A single-electron reduction mechanism or a facilitated two-electron mechanism is preferred, inasmuch as such mechanisms are more efficient and require less electrochemical energy. That is, the mechanism may involve a two-electron reduction but the second reducing electron may be facilitated by protonation of the reduced site upon the first reduction. In variants, a multi-electron reduction mechanism may be relied on.

In particularly advantageous embodiments, the protection moiety P of each of the plurality of compounds C provided comprises a redox-active naphtoquinone chromophore. The protection moiety P may for instance comprises a structural unit with a nucleophile that is decorated in its periphery with said redox-active naphtoquinone chromophore. This way, the structural unit can be cleaved via an intramolecular attack of the nucleophile.

For example, the protection moiety P of each of the plurality of compounds C provided may comprise a trialkylsilane, decorated in its periphery, at one of the alkyl groups of the trialkylsilane, with the naphtoquinone chromophore. The redox-active chromophore can for instance be arranged in such a manner that one of the hydroxyl groups that are formed upon electrochemical reduction to the naphto-hydroquinone can attack the silane intra-molecularily, so as to release a newly formed 1,2-oxasiline cycle (i.e., comprising the naphto-hydroquinone subunit), while leaving behind a free acetylene terminal T on the cleaved compound C′.

Using molecular components C such as described above, the electrochemical cleaving of the protection moiety P can be achieved by applying a low potential between the electrolyte and the surface S, e.g., of less than 2 V (in absolute values).

In embodiments, the method additionally comprises binding further molecular compounds M to the cleaved compounds C′ of the subset, thanks to chemical reactions (e.g., click chemistry reactions) involving the free acetylene terminal T of each of the cleaved compounds.

In preferred embodiments, one or more of the molecular compounds M, M₁, M₂ used for binding comprise an azide functional group. For example, said compounds may comprise biotin-PEG-azide, or a toluoyl protected 1-azido-2-deoxyribofuranose, or any other subunit that exposes an azide group at the periphery of the compound. Possibly, at least two (different) types of molecular compounds M₁, M₂ may be involved, wherein each type of molecular compounds comprises an azide functional group.

In preferred embodiments, the surface S provided comprises two or more distinct, electrically addressable areas, which are electrically insulated from each other, and the plurality of compounds C provided comprises two or more subsets of compounds C, wherein the two or more subsets are arranged in respective ones of the areas. This way, a spatial control of the initial immobilization process and the subsequent deprotection and assembly mechanisms can easily be achieved.

Accordingly, distinct types of molecular compounds M₁, M₂, . . . can be attached to the cleaved compounds C′, for example in a sequential manner, e.g., on distinct horizontal portions of the surface S. For instance, one may first cleave the protection moiety P of a first, selected one of the two or more subsets of the compounds C, so as to obtain a first set of cleaved compounds C′ with a free acetylene terminal T. Next, one may for example bind first molecular compounds M₁ to the first set of cleaved compounds C′, thanks to chemical reactions involving the free acetylene terminal T on the first set of cleaved compounds C′. Again, click chemistry reactions may possibly be relied on.

Preferably then (e.g., after removing the remaining molecular compound M₁ by excessive rinsing), the protection moiety P of a second, selected one of the two or more subsets of the compounds C, is electrochemically cleaved, so as to obtain a second set of cleaved compounds C′ with a free acetylene terminal T (the second subset is distinct from the first one of the subsets, in terms of electrical addressability). Finally then, second molecular compounds M₂ can be bound to the second set of cleaved compounds C′, thanks again to chemical reactions involving the free acetylene terminal T on the second set of cleaved compounds C′.

Unless otherwise stated in this description, the notation “X” refers to a molecular compound prior to binding, cleaving or otherwise processing this compound, while “X” refers to the molecular compound after processing. The final compound X′ may thus slightly differ from the initial compound X, e.g., structurally speaking, as known per se.

In embodiments, the second moiety B of each of the plurality of compounds C provided comprises an oligo(p-phenylene ethynylene). In variants, the second moiety B of each of the plurality of compounds C provided comprises an oligo(p-phenylene vinylene). Such compounds make it possible to easily adapt the spacing of moieties of compounds C to the surface and achieve a tunable electrochemical response by adjusting the distance to the electrode surface.

In preferred embodiments, the first moiety A of each of the plurality of compounds C provided comprises a sulphur anchor and, preferably, the surface S provided comprises noble metals, e.g. Au, Pt, etc., onto which the first moiety A of each of the plurality of compounds C provided is anchored.

In variants, the first moiety A of each of the plurality of compounds C provided comprises an ethylenediaminetetraacetic acid derivative. In such cases, the surface S provided preferably comprises TiOₓ (e.g., on indium tin oxide (ITO)), onto which the first moiety A of each of the plurality of compounds C provided is anchored. This way, transparent electrodes can be functionalized. More generally though, the surface S may possibly comprise noble metals, semiconductors (such as Si, Ge), or conductive oxides.

According to another aspect, the invention is embodied as a device for deprotecting anchored molecular compounds, i.e., a device designed to implement the present methods. The device comprises an electrically addressable surface S and a plurality of compounds C. Each of the compounds C comprises three distinct moieties as described above, i.e., including: a first moiety A, anchored to the surface S; a second moiety B being a molecular backbone B bonded to the first moiety, the second moiety comprising an acetylene unit U; and a third moiety P that is a protection moiety for acetylene, the protection moiety P bonded to the acetylene unit U of the second moiety B via an electrochemically breakable bond b. The surface S is, in the device, adapted to be submerged in an electrolyte, so as for the plurality of compounds C to be immersed in the electrolyte. The protection moiety P is furthermore adapted to be electrochemically cleaved via its respective bond b (thanks to the electrochemical sensitivity thereof), by applying an electric potential between the electrically addressable surface S and the electrolyte, so as to obtain cleaved compounds C′ that comprise, each, a free acetylene terminal T.

As discussed in reference to the present methods, the protection moiety P of each compound C preferably comprises a redox-active naphtoquinone chromophore. The protection moiety P may for instance be a trialkylsilane, decorated in its periphery (at one of the alkyl groups of the trialkylsilane) with said redox-active naphtoquinone chromophore. In addition, the second moiety B of each compound C may for example comprise an oligo(p-phenylene ethynylene) or an oligo(p-phenylene vinylene). Preferably, the first moiety A comprises an ethylenediaminetetraacetic acid derivative. Also, the surface S may for instance comprise noble metals such as Au, Pt, semiconductors such as Si, Ge, or conductive oxides such as TiOₓ.

In addition, the surface S may possibly comprise two or more distinct, electrically addressable areas, which are electrically insulated from each other, whereby the plurality of compounds C may comprise two or more subsets of compounds C, where each of the subsets is arranged in a respective one of the areas, as evoked earlier.

Devices and methods embodying the present invention will now be described, by way of non-limiting examples, and in reference to the accompanying drawings.

### BRIEF DESCRIPTION OF SEVERAL VIEWS OF THE DRAWINGS

The accompanying figures, where like reference numerals refer to identical or functionally similar elements throughout the separate views, and which together with the detailed description below are incorporated in and form part of the present specification, serve to further illustrate various embodiments and to explain various principles and advantages all in accordance with the present disclosure.

FIG. 1A schematically illustrates the general structure of a molecular compound C comprising an anchor A, a backbone B with an acetylene unit U and a protection moiety P bonded to B via an electrochemically breakable bond b, as involved in embodiments.

FIG. 1B illustrates that same molecular compound C anchored on a surface S, via the anchoring moiety A, and further depicts the general structure of a cleaved molecular compound C′, as obtained after cleaving its protection moiety P, thereby unveiling a free acetylene terminal T on its free end, as involved in embodiments.

FIGS. 2A-2D is a sequence that schematically illustrates high-level steps of a method according to embodiments. FIGS. 2A-2B illustrate the deprotection of an anchored molecular compound (such as depicted in FIG. 1A, though A and B are not explicitly shown here). FIGS. 2C-2D depict a subsequent functionalization of the cleaved compound.

FIG. 3A shows examples of subunits of molecules and oligomers that may be used as moieties for said molecular compound C, as in embodiments.

FIG. 3B shows a preferred molecular structure that can accordingly be obtained for said molecular compound C, as in preferred embodiments.

FIGS. 4A-4D is a sequence illustrating the deprotection of an anchored molecular compound C (such as depicted in FIG. 3B), according to embodiments.

FIGS. 5A-5D illustrate subsequent steps of binding various molecular compounds to cleaved molecular compound C′, thanks to chemical reactions involving a free acetylene terminal T of the cleaved compound C′, according to embodiments.

FIGS. 6A-6C are top views illustrating a sequence of steps of electrochemical deprotection and local assembly of molecules, with a device comprising an array of distinct, electrically addressable areas, according to embodiments.

FIGS. 7A-7C are top views of this array, showing, by way of different levels of gray, surface functionalizations of the electrically addressable areas of the array, as obtained after each of the steps corresponding to FIGS. 6A-6C, respectively.

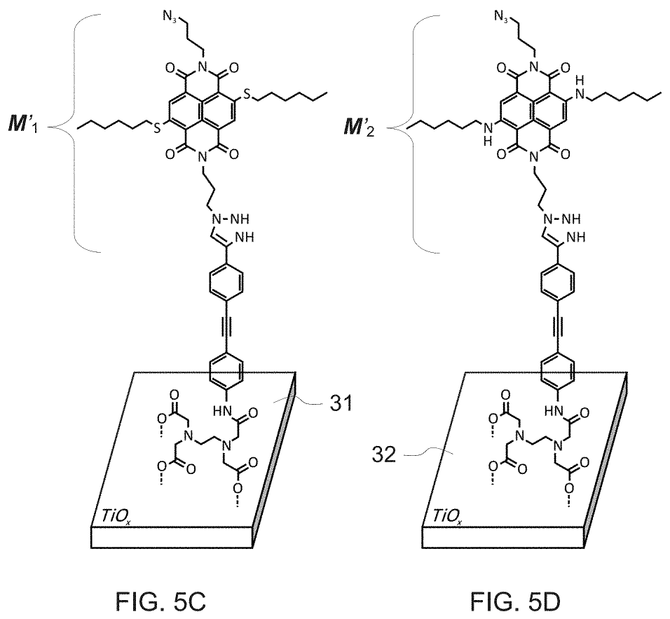

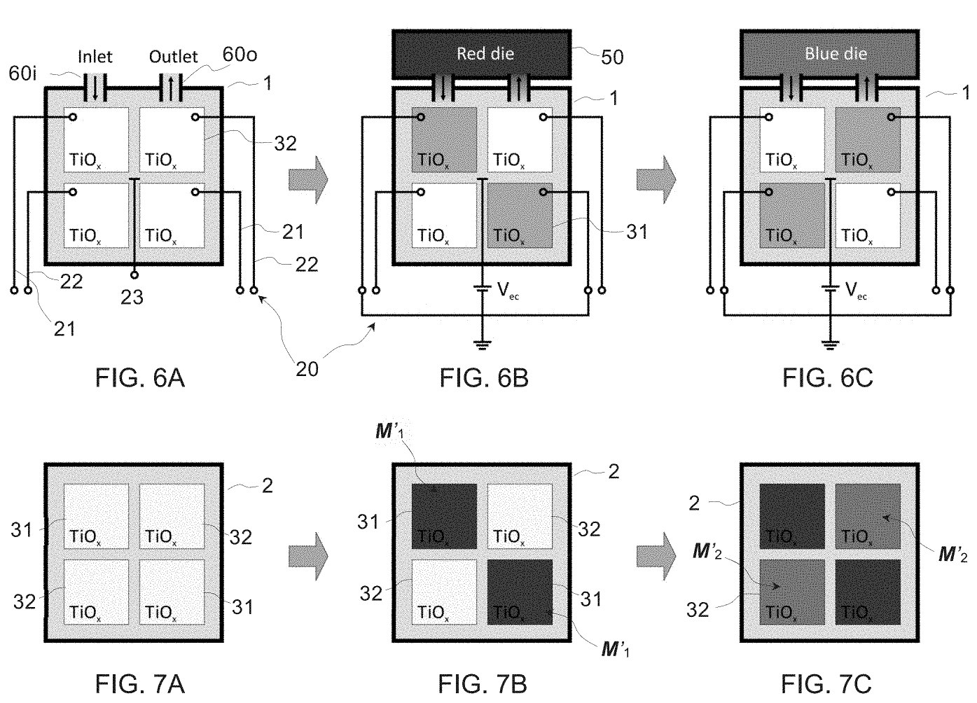

The accompanying drawings show simplified representations of devices or parts thereof, as involved in embodiments. Technical features depicted in the drawings of FIGS. 6, 7 are not necessarily to scale. Similar or functionally similar elements in the figures have been allocated the same numeral references, unless otherwise indicated.

### DETAILED DESCRIPTION OF EMBODIMENTS OF THE INVENTION

The following description is structured as follows. First, general embodiments and high-level variants are described (sect. 1). The next section addresses specific embodiments and technical implementation details (sect. 2) of the present methods.

### 1. General Embodiments and High-Level Variants

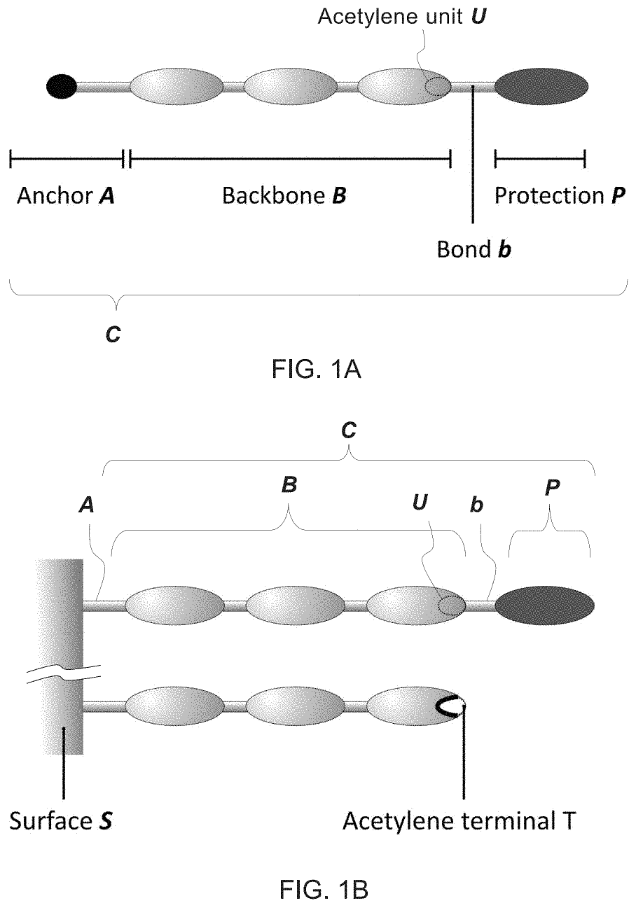

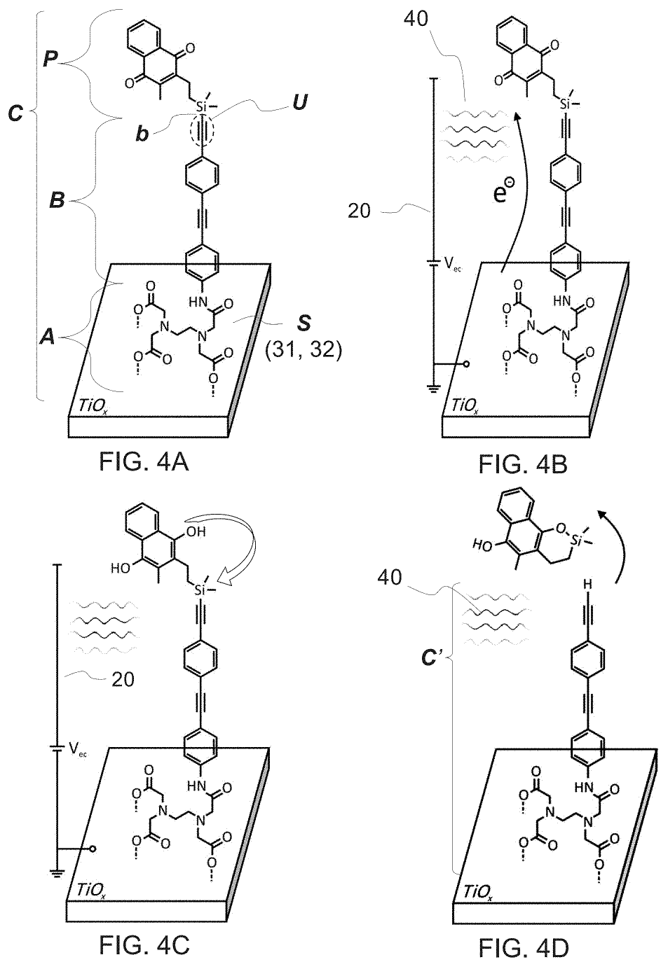

In reference to FIGS. 1-4, an aspect of the invention is first described, which concerns a method for deprotecting anchored molecular compounds. This method requires an electrically addressable surface S and a plurality of molecular compounds C, as illustrated in FIGS. 1B and 4A. Each compound C comprises three distinct moieties. The latter include:
A first moiety A, which is anchored to the surface S, so as to locally immobilize the compound C on the surface 5;
A second moiety B, which is bonded to the first moiety A and can be regarded as a molecular backbone B of a molecular compound C. The backbone B notably comprises an acetylene unit U; and
A third moiety P, which can be regarded as a protection moiety for the acetylene unit of the backbone B. E.g., it prevents the unit U from spontaneously binding. The protection moiety P is bonded to the acetylene unit U of the backbone B via an electrochemically breakable bond b. Such a protection group is a molecular moiety that keeps the acetylene passive under normal (e.g., ambient) conditions and, in particular, when the compound is immersed in the electrolyte, see below.

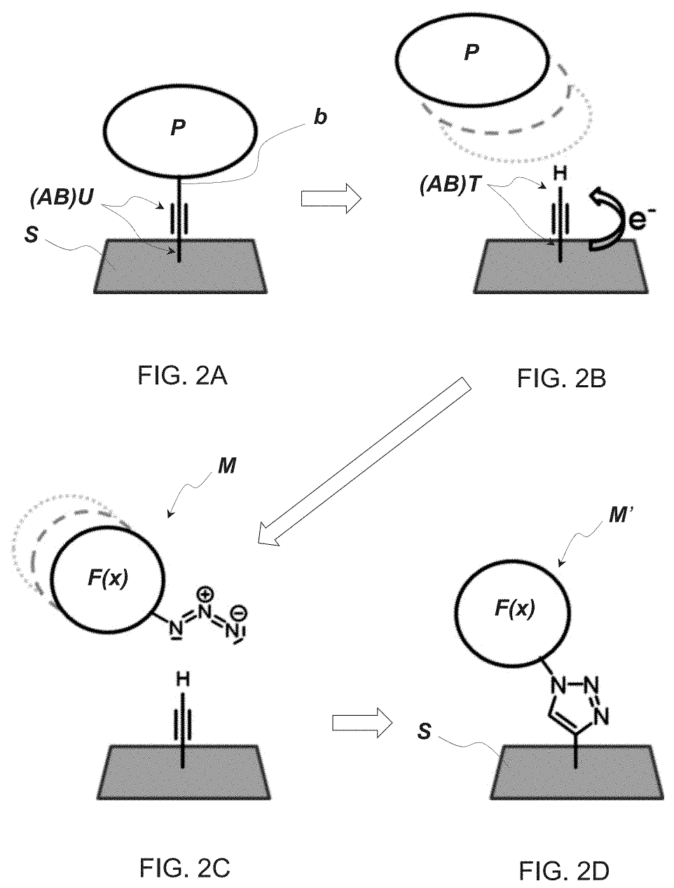

Thus, each compound C has an ABP structure, where B comprises an acetylene unit U, and AB is connected to P via a bond b, as generally depicted in FIG. 1A. The AB structure is not explicitly depicted in FIGS. 2A-2D, for conciseness.

According to the present method, and as illustrated in FIGS. 2B, and 4B-4D, the surface S is submerged in an electrolyte solution, so as for the plurality of compounds C to be immersed in the electrolyte. The protection moiety P is then electrochemically cleaved, by applying an electric potential between the electrically addressable surface S and the electrolyte, which, in turn, causes to electrochemically break the chemical bond b that links moieties B and P. E.g., the protection moiety P can be chosen so as to be reduced by an electrochemical mechanism that breaks the bond b.

This is done so as to eventually obtain a free acetylene terminal T and, this, for each of the cleaved compounds C′. At the end of the deprotection step, each cleaved compound C′ exhibits an acetylene terminal T. The cleaved compound may be terminated by the acetylene terminal T on its free end (on top of the backbone B) or the terminal T may be hanging on a side of the cleaved compound. Yet, the second moiety B is still bonded to the anchoring moiety A, which itself is bonded to the surface S.

A range of electro-chemical mechanisms can be contemplated, possibly involving various intra-molecular processes, in order to electrochemically cleave the protection moiety P of the compounds C. By applying a voltage between the surface S and the electrolyte to which the surface S is otherwise exposed to, an electrochemical process can be initiated locally in the protection moiety P. This electrochemical process may involve a reduction process, where additional electrons are provided from the electrode (i.e., the surface), or an oxidation process, in which electrons are provided from the electrolyte. Chemical transformations follow, as a result of the electrochemically altered reactivity, which eventually result in breaking the bond b and thus cleaving the compound, as discussed in detail and exemplified in sect. 2.

Note that the surface S need not be electrically conducting (no electron transport is strictly needed). Rather, a mere voltage bias need be applied between the surface and the electrolyte. Thus, the process may involve a more or less conductive surface, or a non-conductive surface.

The surface S may for instance be structured. It may for instance involve laterally arranged sections (2D) or be compartmented (3D), so as for the surface to exhibit distinct areas 31, 32 electrically insulated from each other, as later discussed in reference to FIGS. 6, 7. This makes it possible to deprotect only a selected subset of the compounds C (i.e., compounds that are arranged in respective, selected one or more of the areas 31, 32 of the surface S) while keeping other subsets protected. That is, the compounds C need not all be cleaved simultaneously in one step. Rather, one may electrochemically cleave, sequentially, protection moieties P of subsets of the compounds C, thanks to the electrical addressing of the distinct areas 31, 32. This makes it possible to site-selectively functionalize distinct areas, one after another, in a sequential procedure wherein electrical potential are successively applied to distinct areas. Such areas 31, 32 may nevertheless be immersed in the electrolyte, all at a same time, since the deprotection mechanism is locally controlled by the selectively applied potentials.

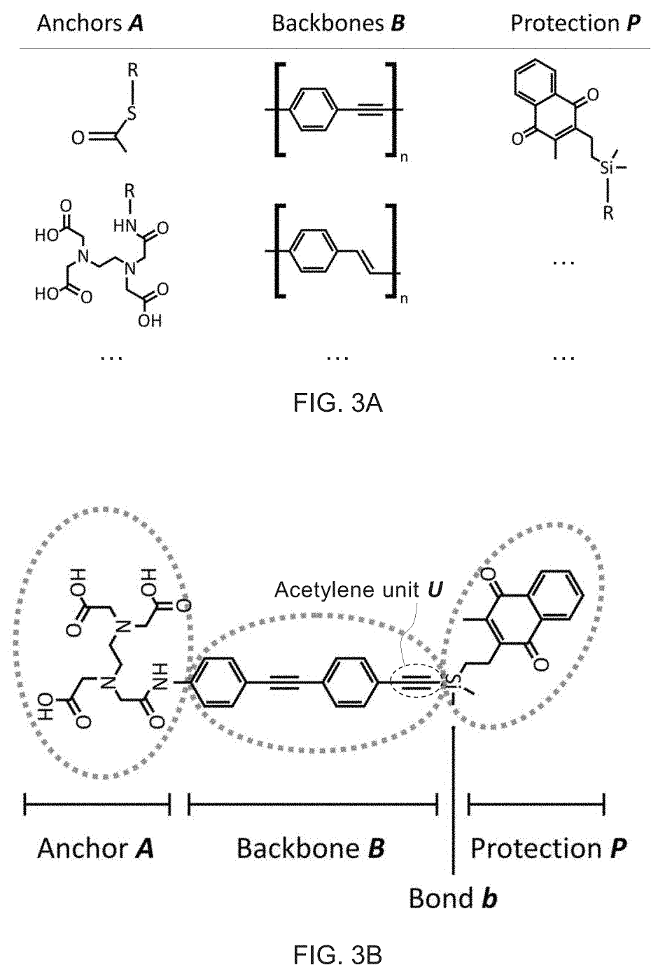

Comments are in order. The terminologies “acetylene unit” and “acetylene terminal” as used herein refer to similar molecular units, which comprise, each, two carbon atoms, bonded together in a triple bond. I.e., “acetylene” as used here specifically refers to C₂H₂, also formally known as ethyne, according to the IUPAC nomenclature. However, the acetylene (ethyne) unit —C≡C— of the backbone acts as an intermediate link between B and P. This acetylene unit U can thus be regarded as a bridge or a connector. In fact, several —C≡C— units may possibly be involved, where such units (but the very last one) link two monomers of the backbone B, as when using, e.g., an oligo(p-phenylene ethynylene) for the backbone (see FIG. 3A, upper panel).

Now, the acetylene (ethyne) terminal obtained after cleaving the protection group P is terminated by a hydrogen atom (—C≡C—H), unlike the acetylene unit U, which links B to P. The free acetylene terminal T obtained after cleaving forms part of the backbone B. It is for example located opposite to the terminal of the molecular backbone B that binds to the anchor A. More generally though, the backbone B may offer various sites to connect to the protection moiety P.

As the protected acetylene unit U is immobilized (via the molecular backbone B and the anchoring moiety A) on the surface S, the present electrochemical deprotection mechanism eventually results in an acetylene-functionalized surface. As it may be realized, a free acetylene terminal T (as eventually obtained after cleaving) provides an ideal basis for sequential build-up in synthetic chemistry. I.e., it provides a chemically flexible attachment, which makes it possible to subsequently bind a large variety of natural and/or artificial molecular compounds to the cleaved compounds C′. Remarkably, a variety of compounds (e.g., azide functionalized) as readily available from a synthetic chemistry libraries can be attached, e.g., using click chemistry techniques and, this, even under mild and ambient conditions.

The high synthetic flexibility makes the present approach generic to a large variety of applications including, e.g., bottom-up assembly of miniaturized electronic building blocks and circuitry, highly selective sensing and binding components, multi-step, cascaded catalysis, light emitters and nanoscale light detectors for displays, molecular quantum-based logics and neuromorphic computing networks.

The local control enabled by the present approach has several advantages. For instance, synthesis can be done in smaller reaction compartments, hence allowing enhanced control over reagents, reaction parameters and reaction conditions. If necessary, a feedback mechanism can be employed to control the reaction conditions. In addition, cascades of reactions can be achieved without intermediate filtering or purification, e.g., for the production of chemicals by multi-step cascaded reactions. Furthermore, a screening of various reaction pathways can be envisioned, as well as additional synthetic modalities such as high-fields, field gradients, pH gradients, etc. As highly constrained volumes can be functionalized site-selectively, nanoscale features (e.g., enabling high electric fields) can be used to enable novel synthetic processes.

Referring now more specifically to FIG. 4B, the protection moiety P is preferably chosen so as for the electrochemical cleaving mechanism to involve a reduction of the protection moiety P. The reduction mechanism assumed in FIG. 4 requires two electrons. However, the second reducing electron is facilitated by the protonation of the reduced site upon the first reduction and thus, there is no additional reduction potential required (there is no over-potential or additional redox wave detectable in that case). Such a reduction mechanism is preferred, inasmuch as it is efficient and requires less energy for activation. In other embodiments, however, a true single-electron process may be contemplated. In variants, multi-electron reduction mechanisms can be used, e.g. to achieve distinct activation barriers for different protection moieties P, hence enabling an electrical addressing at different electrochemical potentials.

The protection moiety P of each compound C preferably comprises a redox-active naphtoquinone chromophore, as assumed in FIGS. 3A, 3B, and 4A. The latter, upon electrochemical reduction as occurring at cleaving the protection moiety P, becomes a naphtohydroquinone exposing two nucleophilic hydroxyl groups. The redox chromophore may notably be arranged in such a manner that one of its hydroxyl group can easily attack a region of the protection group, located close to the acetylene unit U, so as to release the latter and form the acetylene terminal T.

For example, the protection moiety P of each compound C may comprise a trialkylsilane, decorated in its periphery (i.e., at one of the alkyl groups of the trialkylsilane) with said redox-active naphtoquinone chromophore, see FIGS. 3A, 3B, and 4A. As further seen in FIG. 4C, the redox chromophore can be arranged in such a manner that one of its hydroxyl group can easily attack the silane, intra-molecularily, so as to release the acetylene unit and give rise to the desired terminal. More generally though, the protection moiety P may comprise a structural unit with a nucleophile, which is decorated in its periphery a redox-active naphtoquinone chromophore, wherein the structural unit is adapted to be cleaved via an intramolecular attack of the nucleophile.

Relying on a protection moiety as described above makes it possible to electrochemically cleave it by applying a low potential bias to the surface S, with respect to a reference electrode in an electrolyte 40 wetting the surface S. Namely, a potential bias of less than 2 V (in absolute values), and preferably close to 1 V (in absolute values), may suffice in the present case. For example, one may apply a potential of about −900 mV with respect to a saturated calomel reference electrode, as discussed in more detail in sect. 2.

In variants, however, other linkers for the electrochemically addressable bond b can be contemplated. For example, one may consider to use germanium instead of silicon. In addition, heteroatom-based linkers can be envisaged. One possibility, for example, is to use a carbonyl-linked structure forming a cyclic lactone upon reduction.

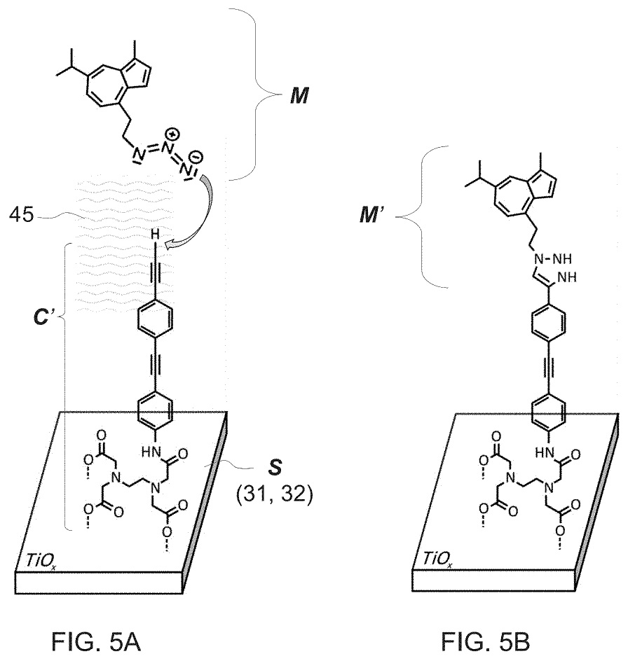

A remarkable interest of the present approach is that it makes it possible to easily bind a variety of molecular compounds M, M₁, M₂, . . . to the cleaved compounds C′, as illustrated in FIGS. 2C, 2D and 5B-5D. This can be achieved thanks to simple chemical reactions, e.g. click chemistry reactions, exploiting the high chemical affinity of the free acetylene terminal T of the cleaved compounds C′.

Click chemistry (also called tagging reactions) as contemplated herein are simple chemical reactions, whereby small modular units are joined to form new units. Such reactions are simple to perform and can be conducted in benign or easily removable solvents. They are further high yield, regio-specific, and do not create additional byproducts. They are often catalyzed by copper ions and frequently additional reducing agents (e.g. ascorbic acid or salts thereof) are used in order to generate Cu(I) ions in situ. All these reagents can be removed without chromatography.

One or more types of molecular compounds M, M₁, M₂, . . . can be contemplated for binding. One may for instance bind two or more types of molecular compounds M₁, M₂, . . . to respective subsets of cleaved compounds C′, by exposing distinct areas 31, 32, . . . of the surface S to distinct solutions. This can notably be achieved sequentially, i.e., by sequentially deprotecting selected areas 31, 32, . . . of the surface S (the latter exposed to an electrolyte) and then exposing the deprotected surfaces to appropriate solutions containing M₁ and, then, M₂, and so on. In variants, compartmented surfaces may be relied on to separately deprotect and expose the various areas 31, 32, . . . , all at the same time. Most simple, however, is to entirely submerge an array of areas 31, 32, . . . on the surface S and then selectively deprotect selected areas (e.g., subsets of the areas) 31, 32, . . . in order to subsequently bind selected compounds molecular compounds M₁, M₂, . . . to the deprotected areas.

Preferably, the molecular compounds M, M₁, M₂, . . . used in the subsequent chemical reaction steps comprise an azide functional group, as in FIGS. 5B-5D, which allows a variety of click reactions and, in turn, a variety of terminal molecular compounds to be assembled. For example, such compounds may advantageously comprise biotin-PEG-azide, and/or toluoyl protected 1-azido-2-deoxyribofuranose, or any other subunit exposing an azide group as discussed in detail in sect. 2. Although the molecular compounds M, M₁, M₂, . . . to be assembled may be of different types, each type of molecular compounds may possibly comprise an azide functional group, as assumed in FIGS. 2C, 2D, and 5B-5D.

For instance, FIGS. 2C and 2D schematically illustrate the binding of a molecular compound M, which comprises an azide functional group and another functional group F(x). After binding, a site-selectively immobilized compound M′ is obtained, whose outward functionality F(x) can now be practically exploited, for applications as mentioned earlier in the background section.

The molecular backbone B of compounds C is now addressed in more details. The second moiety B of each compound C may, for example, comprise an oligo(p-phenylene ethynylene), hereafter noted OPE, as depicted in FIG. 3A, upper panel. OPEs are a class of fluorescent molecules that offer a large tunability regarding their length. Preferably, one relies on (OPE2), as in FIGS. 3B, 4 and 5. Such an oligomer turns out to be surprisingly flexible, inasmuch as it allows the (out-of-plane) spacing of the moieties of the compounds C to the surface S to be very accurately tuned, e.g., with Angstrom accuracy.

In variants, the second moiety B may comprise an oligo(p-phenylene vinylene), noted OPV, as illustrated in FIG. 3A (middle panel), or an oligo(p-phenylene), noted OP, or any other structurally robust architecture allowing the anchor group A to be connected with an acetylene unit U masked with P.

In all cases, one may vary the number (n, m, 1) of monomers of the (OPEn), (OPVm) and/or (OP/) oligomers, so as to adjust the out-of-plane length of the compounds C, e.g., in order to modulate the electrochemical response. Yet, backbone structures as preferably contemplated herein are typically short enough, so that the electrochemically triggered masking group remains within the Helmholtz-layer sensible to the applied electrochemical potential.

Concerning now the anchoring, the first moiety A of each compound C may for example comprise thiols, amines, etc., which are known to bond covalently to metal surfaces. Other anchors may involve trimethylthin or trimethyl-silyle caped carbons that are actively or passively cleaved when getting in contact with metal surfaces to form direct C-metal σ bonds.

In variants, anchoring moieties A can also be protected by a protection group, such as acetyl-protected sulphur, which are released either spontaneously, e.g. by hydrolyzation, or actively, e.g. by adding a deprotection reagent. Deprotection of the anchoring moiety A prevents agglomeration and polymerization in high-concentration solutions, e.g. by formation of R—S—S—R bonds.

In other variants, the anchor moieties A comprise alkoxy silanes and/or halo silanes, which form covalent bonds on silica substrates and may function as electrodes when suitably doped. For example, a dimethyl-ethoxysilane forms monolayers on silica substrates via covalent Si—O—Si(Me)₂—R bonds.

In still other variants, anchoring moieties A may comprise an ethylenediaminetetraacetic acid (EDTA) derivative, to ease implementation and optical characterization. Indeed, EDTA derivatives were found to adhere well to, e.g., oxide surfaces such as a TiOₓ surfaces, which are both conducting and transparent. Consistently, the surface S preferably comprises TiOₓ, onto which anchors A such as EDTA derivatives can easily be anchored. More generally, a wide range of anchoring moieties can be employed, e.g., which are able to bind to semiconductor surfaces.

All this is discussed in detail in sect. 2.

Referring more specifically to FIGS. 6 and 7, another aspect of the invention is now described, which concerns a device 1 designed for deprotecting anchored molecular compounds. Main aspects of this device 1 have already been described in reference to the present methods. Essentially, the device 1 comprises a surface S, onto which are arranged a plurality of compounds C, having an ABP structure as described above.

Namely, a first moiety A (e.g., an EDTA derivative or a thiol anchor) of each compound C is anchored to the surface S (e.g., comprising electrically addressable areas coated with TiOₓ). The molecular backbone B, e.g., (OPEn), (OPVm), or (OP/), is bonded to the anchor A and the third moiety P is bonded to the acetylene unit U of the backbone via an electrochemically breakable bond b. As discussed earlier, the protection moiety P of each compound C may notably be a trialkylsilane decorated with a redox-active naphtoquinone chromophore. In all cases yet, the protection moiety P is adapted to be electrochemically cleaved via this breakable bond b, so as to give rise to cleaved compounds having free acetylene terminals T. That is, the surface S is configured, in the device, so as to be submerged in an electrolyte, such that the compounds C may be immersed in the electrolyte. Then, protection moieties P can be electrochemically cleaved by applying an electric potential between the electrically addressable surface S and the electrolyte.

The device is preferably provided with an electrical circuit 20 (or circuit portions 21, 22), adapted to apply the needed electrochemical potentials.

Preferably, the surface S comprises two or more distinct, electrically addressable areas 31, 32 (i.e., regions), which are electrically insulated from each other. This surface S may notably be structured so as to form an open electrode structure, where the distinct areas 31, 32 are arranged side-by-side in an array, as in FIGS. 6 and 7. The various areas 31, 32 can be sequentially processed, so as to eventually obtain molecular compounds M′ⱼ assembled on respective one or more of the areas, as described below.

In variants, the areas 31, 32 may form any arbitrary, e.g., irregular, pattern. In other variants, such areas 31, 32 may result from 3D compartments provided in the device, as evoked earlier. That is, the device may possibly comprise compartments with respective electrically addressable areas 31, 32, which can then be processed simultaneously. Also, the device may comprise micro- and/or nano-fluidics structures, as well as, e.g., integrated solvent delivery 50, electrical pads and circuits 20-22 to connect to distinct areas 31, 32. Moreover, the device may be configured so as to integrate electrochemical cells. In all cases, the present devices may include one or more gas and/or solvent supplies 50, as well as inlets 60i/outlets 60o, so as to conveniently bring gas and/or solvent 40, 45 onto the surface S, or specifically to each compartmented surface areas.

The present devices may be embodied as optical sensing devices, bio sensing devices, chemical sensing devices, micro- or nanosynthesis systems, or, still, as light-generating devices based on electroluminescence or on photovoltaic effects. Various surface coatings can be contemplated as well.

In all such variants, the compounds C provided may be arranged in distinct subsets, where the subsets are arranged in respective areas 31, 32, as assumed in FIG. 7A.

The embodiment of FIGS. 6 and 7 depict a device 1 comprising an electrical circuit 20 that includes a set of components 21, 22, which suitably connect to distinct sets 31, 32 of electrically addressable surface areas, as well as a reference electrode 23 located so as to contact an electrolyte solution wetting the array 2, in operation. The circuit design shown in FIGS. 6, 7 makes it possible to independently bias distinct (sets of) areas 31, 32, which form an open electrode structure in that case. Thus, an electrochemical potential V_{ec} can be sequentially applied to selected sets 31, 32 of areas (two areas at a time in this example) for deprotecting respective subsets of compounds C arranged thereon. This way, a spatial control of the electrochemical deprotection mechanism can easily be achieved, i.e., by applying a voltage bias V_{ec} between selected electrodes (31 or 32) and a reference electrode 23, the latter wetted by an electrolyte solution, even though the entire array 2 of areas 31, 32 is immersed in the electrolyte.

For example, and after having immobilized compounds C on all the surface areas 31, 32 (FIGS. 6A, 7A), one may first cleave (FIG. 6B) protection moieties P of compounds C arranged on first, selected areas 31, so as to give rise to free acetylene terminals on the free ends of the cleaved compounds C′. Then, e.g., after rinsing, first molecular compounds M₁ from a solution 45 can subsequently be bonded (FIG. 6B) to the cleaved compounds C′ of the first areas 31, e.g., by chemical reactions involving the free acetylene terminals, as explained earlier. As a result, a patterned array result (FIG. 7B), where a first molecular compounds solely bind to compounds on the selected areas 31 (dark gray areas). Next, by electrochemically cleaving (FIG. 6C) protection moieties P of the remaining areas 32, one may subsequently bind (FIG. 6C) second molecular compounds M₂ (from another solution 45) to the cleaved compounds C′ on such areas 32 (e.g., again by chemical reactions; gray areas). The pattern 2 eventually obtained (FIG. 7C) is functionalized with distinct molecular compounds M′₁ and M′₂ assigned to distinct sets 31, 32 of areas.

Depending on the target pattern to be achieved, different number of separated areas and assembly steps may be required, not being limited to two as exemplarily shown in FIGS. 6 and 7.

The above embodiments have been succinctly described in reference to the accompanying drawings and may accommodate a number of variants. Several combinations of the above features may be contemplated. Examples are given in the next section.

### 2. Specific Embodiments

In this section, a specific molecular-immobilization strategy is discussed in detail, which is based on the electrochemical deprotection mechanism disclosed in sect. 1. This strategy relies on a trialkylsilane protection group for acetylenes, which is decorated in its periphery (at one of the alkyl groups) with a redox-active naphtoquinone chromophore. Upon electrochemical reduction, the naphtoquinone becomes a naphtohydroquinone exposing two nucleophilic hydroxyl groups. The redox-active chromophore is arranged in such a manner that one of its hydroxyl group can easily attack the silane bond connecting to the acetylene unit U (by way of an intra-molecular mechanism), so as to release it from the acetylene terminal T. As the protected acetylene unit U is initially immobilized on the electrode surface via the molecular backbone B and the anchoring moiety A, the electrochemical deprotection mechanism eventually leads to an acetylene-functionalized, locally addressable surface and thus, a chemically flexible attachment for binding a large variety of natural and artificial molecular compounds. One may, for instance, use azide functionalized molecular compounds that are readily available from a synthetic-chemistry library and can thus be attached via “click chemistry” under mild and ambient conditions. The high synthetic flexibility of this novel approach makes it potentially suited for a large variety of applications, as mentioned in sect. 1.

The molecular immobilization procedure discussed in this section relies on compounds C as described earlier, i.e., comprising three different moieties ABP. Each compound C is able to anchor to the surface S via an anchoring moiety A. The protection moiety P can be selectively cleaved by electro-chemical means. The deprotection does neither affect the bond of the anchoring moiety A to the surface S nor the molecular backbone B of the compound C (except for P itself). After deprotection, the remaining molecular backbone B of a cleaved compound C′ offers a free acetylene terminal T, e.g., at the end opposite to the anchoring moiety A, for subsequent binding of further moieties.

The molecular component C is schematically depicted in FIG. 1A. Its anchoring moiety A may be tailored for anchoring to a specific surface S (see FIG. 1B). The oligomeric backbone B provides a tailorable distance from the surface S. Of remarkable interest is the electrochemically breakable bond b between the protection group P and the backbone B.

As one may realize, free acetylenes (ethynes) as termini of a molecular backbone may constitute an ideal basis for sequential build-up in synthetic chemistry. Having a method where a molecular compound is first immobilized on a surface and the acetylene terminal T is then controllably and locally made available for further synthetic reactions (via a trigger) is highly favorable for various kinds of molecular integration. So far, and to the best knowledge of the present inventors, no examples of synthetic realization of a compound fulfilling all the above requirements have been described in the scientific and technical literature.

The present inventors have notably synthetically realized the compound shown in FIG. 3B, which has the same generic structure as in FIG. 1A. In this example, the anchor group A is chosen to be an ethylenediaminetetraacetic acid (EDTA) derivative, which happens to adhere well to TiOₓ surfaces. The latter are both conducting (electrically) and transparent, which makes the molecular surface decoration directly visible to the bare eye in case of micrometer thick TiOₓ to ease detection. In the EDTA anchoring moiety A, bonding occurs via the strong interaction of the exposed carboxylic acids with the TiO₂ surface. For applications involving noble metal surfaces, however, the anchor moiety A can be replaced by a more conventional anchoring moiety, such as acetyl-protected Sulphur forming thiol linkers to, e.g., an Au surface (see FIG. 3A, upper left panel).

In the example of FIG. 3B, the molecular backbone B comprises an oligo(p-phenylene ethynylene), namely (OPE2). Such compounds involve repeating benzene-subunits and C═C triple bond variations, which result in a rigid rod-like backbone, allowing the spacing of the electrochemical moieties to the surfaces to be tuned with up to Angstrom accuracy, owing to the flexibility offered by the possibility to simply add such subunits to the molecular backbone B.

The protection group P comprises an electrochemically active naphtoquinone, attached to the (OPE2) backbone via a silane, which allows the chemical bond to be electrochemically broken (via an intramolecular cyclization triggered by the reduction of the redox-active naphtoquinone chromophore).

The immobilization on a surface, the electrochemical deprotection mechanism and the click-chemistry, coupling (build-up) reaction are schematically depicted in FIGS. 4-5. The deprotection mechanism is illustrated in detail in FIGS. 4A-4D, while the result of subsequent click-chemistry coupling reactions are depicted in FIGS. 5A-5D.

In detail, FIG. 4A shows a molecular compound C immobilized on a TiOₓ electrode surface. The compound C comprises an EDTA derivative as anchoring group A, an OPE2 backbone B separating the functional acetylene, which is protected by the protection group P, from unwanted reactions occurring under ambient conditions. The successful grafting of compound C onto the almost fully transparent TiOₓ surface is evidenced by a color change. I.e., a slight pale yellow color of the otherwise transparent electrode indicates the presence of the immobilized structure, which translates into slightly different gray levels of the areas 31, 32 in FIG. 7A, compared with FIG. 6A. For the liberation of the acetylene units U, an electrochemical potential is applied to reduce the naphtoquinone subunit into its hydroquinone form. FIG. 4B illustrates the electrochemical reduction of the naphtoquinone subunit to naphto-hydroquinone species. In practice, a potential of about −900 mV vs. saturated calomel electrode 23 (or SCE, not shown in FIGS. 4-5, see FIG. 6) can be applied to the TiOₓ electrode surface 31, 32. The electro-reduction makes the naphtoquinone accept formally two electrons and two protons from the electrolyte (solvent) 40, FIG. 4B. FIG. 4C depicts the intramolecular attack of one of the hydroxyl-group of the naphto-hydroquinone on the trialkylsilyl-subunit connecting to the acetylene unit. This, in turn, results in liberating the acetylene unit, to yield an acetylene terminal T immobilized and exposed at the electrodes surface, FIG. 4D.

The free acetylenes exposed at the electrodes surface can now be engaged in click chemical coupling reactions, FIG. 5. Click chemistry reactions are feasible given the free acetylene, which are, in particular, appealing due to the very mild and ambient reaction conditions they enable, making the concept accessible to a huge variety of (biological and synthetic) molecular systems already comprising functional groups.

For example, in the presence of Cu(I) ions, the immobilized acetylene unit may form a copper acetylide (not shown), which reacts with molecules exposing an azide group (R—N₃). I.e., from the cleaved compound obtained (FIG. 5A, where the residual, cleaved compound is equivalent to that obtained in FIG. 4D), a click reaction occurs between a copper acetylide (not shown) transiently formed on top of the acetylene terminal T and an azide functionalized naphthalene-diimide (NDI) dye, hence yielding a triazole structure linking the NDI dye M covalently to the electrode surface (FIG. 5B), yielding compound M′ attached to the compound C. That is, the copper acetylide and the azide react to a heterocyclic triazole, which covalently interlinks the azide-exposing molecule and the immobilized acetylene. The presence of the immobilized dye M′ can be detected by the resulting blue color of the processed electrode, visible to the naked eye.

Advantageously, such a reaction can be performed under very mild reaction conditions. For example, one may use tetrahydrofurane at room temperature for two hours in the presence of catalytic amounts of Cu(MeCN)₄PF₆ (Tetrakis(acetonitrile)copper(I) hexafluorophosphate) as source of Cu(I) and Tris[(1-benzyl-1H-1,2,3triazol-4-yl)methyl]amine (TBTA) as ligand dissolving Cu(I) in the solvent.

The entire sequence of immobilizing the compound C, its electrochemical deprotection and the subsequent engagement in click-chemistry coupling reactions is best visualized by immobilizing multiple dye molecules in sequence. For example, in order to visualize the immobilized molecules, two core substituted naphthalene diimide (NDI) dyes were synthesized (their color can be adjusted by the core substituents), as now described in reference to FIGS. 5C and 5D. While the alkylamine-core substituted NDI M₂ has an intense and brilliant blue color, the corresponding alkylsulfide substituted derivative M₁ is red, which translates into different gray levels in FIG. 7C. To enable immobilization by click chemistry, both core substituted NDIs are further functionalized with azide groups attached at the imide nitrogens, as seen in FIGS. 5C and 5D.

As said earlier, a light yellow color of the electrode denotes a successful, immobilization of the compound C, which, initially, is terminated by the electrochemically addressable acetylene protection group (FIGS. 4A, 7A). This is due to the fact that the electrochemically active naphtoquinone subunit is itself a light yellow dye. The optical absorption is for instance directly visible by bare eye when, e.g., using a 5×5 mm TiOₓ area 31, 32 of around 10 μm thickness, functionalized with such compounds C, as in preferred embodiments. Upon electrochemical deprotection (FIGS. 4B-4D) and cleavage of the protection group P, the electrode changes to colorless as the cleaved compounds C′ itself are almost colorless.

FIGS. 5C and 5D illustrate cleaved compounds C′ treated with a click protocol, so as to be exposed to two different dye-containing solutions. FIG. 5C depicts the immobilization of a hexylsulfide core substituted NDI M₁ as red dye, while FIG. 5D depicts the covalent attachment of a hexylamine core substituted NDI M₂ as blue dye. Note that due to the covalent attachment eventually obtained, such dyes are not washed away but remain attached to the electrode 31, 32 also under extensive rinsing and long exposure times to various solvents.

The specific embodiments described above enable a variety of natural and artificial compounds to be subsequently attached under mild conditions. The following table list a few examples of receptors that can be attached thanks to the free acetylene terminals eventually obtained.

TABLE 1
Examples of compounds M (corresponding functionalities and applications) that can be
attached to a free acetylene terminal T after electrochemical deprotection.

| Compound | Function and Coupling | Application |
|---|---|---|
| Galactosyl azide | Azide group reacts with acetylene T | Labelling |
| | forming a triazole and thereby | oligonucleotides with |
| | covalently immobilizes galactose | carbohydrates |
| | molecule on surface S. Sugar | Analyzing interactions of |
| | decorated electrodes become | biomolecules and/or cells with |
| | available, e.g. with a variety of | sugar surfaces |
| | different mono- and/or | |
| | oligosaccharides on different | |
| | electrodes | |
| Toluoyl protected 1- | Coupling to nucleobase | Antiviral agents |
| azido-2- | analogues for oligonucleotides | |
| deoxyribofuranose | | |
| Oligonucleotide- | Coupling to olionucleotide-5′-50- | Ligation of DNA |
| Azide-3′- | propargylamido thymidin | |
| Azidothymidin | | |
| Biotin-PEG-Azide | Coupling to alkyene immobilized on | Labeling of molecules by |
| | surfaces | affinity of biotin to streptavidin- |
| | | FITC |
| (S-Tag)- | Coupling to alkyne-PEG | Immobilization of proteins on |
| Thrombomodulin- | functionalized glass slides | surface |
| Azide | | |
| Green fluorescent | Coupling to alkyne-functionalized | Control of site specifically |
| proteins-azide | glass slides | surface functionalization |
| | | Demonstration of successful |
| | | immobilization of large protein |
| | | with remaining functionality |
| Antibody (rabbit | Coupling to alkyne-functionalized | Spatial control of antibody |
| IgG)-Z₃₂BPA-Azide | electrode | decoration enables arrays for |
| | | investigation/analyses of |
| | | antibody/pathogen interactions |
| Steroids-Azide | Coupling to alkyne-functionalized | Spatial control over |
| | electrode | decoration with steroids |
| | | provide arrays for |
| | | identification of their |
| | | receptors and for |
| | | investigation of |
| | | steroids/receptor interactions |
| 5-Fluorescein-Azide | Coupling to alkyne-functionalized | Fluorescent labeling of exposed |
| Pyrene-Azide | electrode | acetylene. Can be used to proof |
| 5-TAMRA-Azide | | the presence of suitably alkyne |
| | | functionalized bio-molecule |
| Cyclodextrin-Azid | Coupling to porphyrin | Porphyrin and |
| | | cyclodextrin arrays |
| Au-Nanoparticles- | Alkyne-dyes, alkyne-ferrocene | Functionalization of Au |
| Thiolalkylazide | | nanoparticles |

The site-selective immobilization and local assembly strategies proposed herein may involve various device configurations. In particular, a large range of electrode surface terminations can be contemplated, which include oxides (e.g., TiOₓ), metals (e.g., Au, Pt, Pd), semiconductors (e.g., Si, Ge or III-V semiconductor materials), 2D-layered materials, such as graphene, VO₂, MnO₂ and other transition-metal dichalcogenide (TMDC).

In addition, such devices may involve:
Nanopores;
Open electrode structures;
Compartments with electrically addressable surfaces;
Micro- and nanofluidics structures with integrated solvent delivery and electrically addressable surfaces;
Electrochemical cells; and
Various surfaces coatings.

Moreover, as a skilled person will appreciate, such devices may be embodied as:
Optical sensing devices;
Bio sensing devices;
Chemical sensing devices;
Electrical devices;
Optical devices;
Plasmonic devices;
Electro-optical devices;
Memory devices;
Light-generating devices based on electroluminescence; and
Light-harvesting devices based on photovoltaic effect.

Most remarkably, the free acetylene terminals obtained thanks to the present methods allow a remarkably large variety of functional molecular compounds to be attached (as exemplified in Table 1). Such compounds can be tailored for many potential applications, including:
Sensing applications, e.g., bio-molecule binding;
Selective functionalization of catalysts for multistep and convergent synthesis;
Bottom-up assembly of molecular electronic, quantum-based or neuromorphic circuits; and
Bottom-up assembly of light-emitting or light-harvesting devices, e.g., displays, detectors, etc.

While the present invention has been described with reference to a limited number of embodiments, variants and the accompanying drawings, it will be understood by those skilled in the art that various changes may be made and equivalents may be substituted without departing from the scope of the present invention. In particular, a feature (device-like or method-like) recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims. In addition, many other variants than explicitly touched above can be contemplated.

What is claimed is:

1. A method for deprotecting anchored molecular compounds, the method comprising:
providing an electrically addressable surface 5;
providing a plurality of compounds C, each comprising three distinct moieties, including:
a first moiety A, anchored to the surface 5;
a second moiety B being a molecular backbone B bonded to the first moiety, the second moiety comprising an acetylene unit U; and
a third moiety P that is a protection moiety for acetylene, the protection moiety P bonded to the acetylene unit U of the second moiety via an electrochemically breakable bond b;
submerging the surface S in an electrolyte, so as for the plurality of compounds C to be immersed in the electrolyte; and
electrochemically cleaving the protection moiety P of at least a subset of the compounds C, via a respective one of the breakable bonds b, by applying an electric potential between the electrically addressable surface S and the electrolyte, so as to obtain cleaved compounds C′ comprising, each, a free acetylene terminal T.

2. The method according to claim 1, wherein cleaving the protection moiety P is carried out via an electrochemical reduction of the protection moiety P.

3. The method according to claim 2 wherein the protection moiety P of each of the plurality of compounds C provided comprises a redox-active naphtoquinone chromophore.

4. The method according to claim 3, wherein the protection moiety P of each of the plurality of compounds C provided further comprises a structural unit with a nucleophile decorated in its periphery with said redox-active naphtoquinone chromophore, wherein the structural unit is adapted to be cleaved via an intramolecular attack of the nucleophile.

5. The method according to claim 4, wherein electrochemically cleaving the protection moiety P is achieved by applying a potential bias of less than 2 V, in absolute values, to the surface S, with respect to a reference electrode.

6. The method according to claim 1, wherein the method further comprises binding molecular compounds M to the cleaved compounds C′ of the subset, due to chemical reactions involving the free acetylene terminal T of each of the cleaved compounds C′.

7. The method according to claim 6, wherein one or more of the molecular compounds M used for binding comprise an azide functional group.

8. The method according to claim 6, wherein said one or more of the molecular compounds M used for binding comprise biotin-PEG-azide.

9. The method according to claim 6, wherein said one or more of the molecular compounds M used for binding comprise toluoyl protected 1-azido-2-deoxyribofuranose.

10. The method according to claim 6, wherein the molecular compounds used for binding comprise at least two types of molecular compounds M₁, M₂, wherein each type of molecular compounds comprises an azide functional group.

11. The method according to claim 1, wherein:
the surface S provided comprises two or more distinct, electrically addressable areas that are electrically insulated from each other and the plurality of compounds C provided comprises a plurality of subsets of compounds C arranged in respective one or more of said two or more distinct areas; and
at cleaving, the protection moiety P of a first, selected one of the subsets of the compounds C is cleaved so as to obtain a first set of cleaved compounds C′ having, each, a free acetylene terminal T.

12. The method according to claim 10, wherein the method further comprises binding first molecular compounds M₁ to the first set of cleaved compounds C′, due to chemical reactions involving the free acetylene terminal T of each of the cleaved compounds C′ of the first set.

13. The method according to claim 11, wherein the method further comprises:
electrochemically cleaving the protection moiety P of a second, selected one of the subsets of the compounds C, distinct from the first one of the subsets, so as to obtain a second set of cleaved compounds C′ having, each, a free acetylene terminal T; and
binding second molecular compounds M₂ to the second set of cleaved compounds C′, thanks to chemical reactions involving the free acetylene terminal T of each of the cleaved compounds C′ of the second set.

14. The method according to claim 1, wherein the second moiety B of each of the plurality of compounds C provided comprises an oligo(p-phenylene ethynylene).

15. The method according to claim 1, wherein the second moiety B of each of the plurality of compounds C provided comprises an oligo(p-phenylene vinylene).

16. The method according to claim 1, wherein the first moiety A of each of the plurality of compounds C provided comprises an ethylenediaminetetraacetic acid derivative.

17. The method according to claim 15, wherein the surface S provided comprises one or each of: TiOₓ and one or more noble metals.

18. A device for deprotecting anchored molecular compounds, the device comprising:
an electrically addressable surface S; and
a plurality of compounds C, each comprising three distinct moieties, including:
a first moiety A, anchored to the surface S;
a second moiety B being a molecular backbone B bonded to the first moiety A, the second moiety B comprising an acetylene unit U, wherein the surface S is, in the device, adapted to be submerged in an electrolyte, so as for the plurality of compounds C to be immersed in the electrolyte; and
a third moiety P that is a protection moiety for acetylene, the protection moiety P bonded to the acetylene unit U of the second moiety via an electrochemically breakable bond b, wherein the third moiety P is adapted to be electrochemically cleaved via its respective of the breakable bond b, by applying an electric potential between the electrically addressable surface S and the electrolyte, so as to obtain cleaved compounds C′ comprising, each, a free acetylene terminal T.

19. The device according to claim 18, wherein the protection moiety P of each of the plurality of compounds C comprises a redox-active naphtoquinone chromophore.

20. The device according to claim 18, wherein the protection moiety P of each of the plurality of compounds C is a trialkylsilane, decorated in its periphery, at one of the alkyl groups of the trialkylsilane, with said redox-active naphtoquinone chromophore.

21. The device according to claim 18, wherein the surface S comprises two or more distinct, electrically addressable areas electrically insulated from each other and the plurality of compounds C comprises several subsets of compounds C arranged in respective ones of the areas.

22. The device according to claim 18, wherein the second moiety B of each of the plurality of compounds C comprises an oligo(p-phenylene ethynylene).

23. The device according to claim 18, wherein the second moiety B of each of the plurality of compounds C comprises an oligo(p-phenylene vinylene).

24. The device according to claim 18, wherein the first moiety A of each of the plurality of compounds C comprises an ethylenediaminetetraacetic acid derivative.

25. The device according to claim 23, wherein the surface S comprises one or more noble metals.
